(19) United States
(12) Patent Application Publication
(10) Pub. No.: US 2014/0113041 A1
(43) Pub. Date: Apr. 24, 2014

(54) Method of processing meat to enhance moisture retention

(71) Applicant: Chris J. Topps, Rancho Cucamonga, CA (US)

(72) Inventor: Chris J. Topps, Rancho Cucamonga, CA (US)

(73) Assignee: QST Ingredients and Packaging, Inc., Rancho Cucamonga, CA (US)

(21) Appl. No.: 13/999,035

(22) Filed: Aug. 1, 2013

Related U.S. Application Data
(63) Continuation of application No. 11/823,183, filed on Jun. 27, 2007.

(51) Int. Cl. A23B 4/023

(52) U.S. Cl. CPC A23B 4/0235
USPC 426/281; 426/332; 426/295; 426/327

(57) ABSTRACT

The present invention is in the field of processing and treating meat. More particularly, the present invention relates to a method of processing meat to enhance moisture retention both during storage and cooking by administering a composition containing sodium carbonate and other ingredients.

### TECHNICAL FIELD

The present invention is in the field of processing and treating meat. More particularly, the present invention relates to a method of processing meat to enhance moisture retention both during storage and cooking by administering a composition containing sodium carbonate and other ingredients.

### BACKGROUND OF THE INVENTION

By weight, water constitutes the largest portion of a food animal. The amount of water is usually found in the range 70-80%. Part of this water is found in free form while the rest is bound to proteins, especially myofibrillar proteins, through charged and polar groups. The amount of immobilized water depends on the available space within the myofibrillar structure and, in fact, the volume of myofibrils is decisive to the water-binding capacity of the muscle. Some variations exist between muscles due to the types of muscle fibers, degree of fiber contraction and pre-rigor pH. The water retention also depends on the ultimate pH reached after rigor mortis and this will have a strong influence on the activity of muscle enzymes involved in proteolysis and lipolysis during ageing and further processing. Variations may be also expected between animal or fish species and age at slaughter.

From the time an animal is slaughtered, its carcass begins to lose water, which results in a shrinkage, or weight loss, of the meat. This weight loss, which begins at slaughtering, continues through the refrigeration and butchering steps in meat processing, and also continues during cooking. The weight loss results in the meat generally becoming tougher, there is less amount of product to sell, and that product is of diminished quality. Furthermore, cooking shrinkage results in a still smaller amount of cooked meat served for ultimate consumption.

Before reaching the consumer, most foods are processed in some way. For example, meat products are separated from unusable or undesirable elements or components, ground or chopped, mixed or blended, and can be frozen for distribution.

Meat treatments are well known for enhancing the appearance and flavor of meat products for use by consumers. For example, the pH of a meat carcass immediately decreases due to glycolysis by muscle tissues. Accordingly, one of the most common meat treatments consists of using an alkylating agent to increase the pH. The pH can also be increased to prevent microbes from contaminating the meat. See, for example, U.S. Pat. Nos. 6,899,908 and 6,713,108. This process returns the meat to a more pre-slaughter state. However, many such treatments result in diminishing water retention and storage stability.

Commercial meat marinades are usually added to the meat in a large rotating barrel-like tumbler. During tumbling, vacuum pressure is applied, as it helps the marinade to penetrate into the meat.

In the meat industry, it is desirable for meat products to retain moisture during storage and cooking. This is true for all meat products, such as beef, poultry, fish, shellfish, etc., which may contain as much as 75% moisture. In addition to retention of natural moisture, i.e., water and fat, it is desirable that the meat retain any moisture added during meat processing. The ability to maintain total moisture enhances the ability of the meat products to retain flavor, and also enhances juiciness and tenderness of the cooked product. Loss of liquid reflects loss of water and liquid fat, which collectively make up the juice of the meat. Shrinkage during cooking reflects the loss of liquid, and can be measured by weight loss of the meat. In addition, the overall appearance of the meat is not enhanced and quality is diminished when excessive moisture is lost during cooking. For example, untreated poultry fibers often appear dried and stringy after cooking, whereas treated poultry fibers exhibit a more natural looking appearance.

Phosphates are also commonly used in the meat industry to raise the pH of the meat to increase the water holding capacity of the protein fibers. One such process is described in U.S. Pat. No. 4,818,528 that teaches treating and packing fresh meat to retain the fresh meat color of the meat and to postpone microbial deterioration and spoilage of the meat. However, phosphate treatments have a tendency to diminish texture, appearance and flavor in meat products. Meats that have undergone phosphate treatments are commonly known in the meat industry as being “over-processed” or having a “processed” look and/or taste.

Other meat treatments are also known in the industry. For example, Published U.S. Patent Application No. US2004/0219283 describes the use of trehalose to treat uncooked meat in order to decrease shrinkage during cooking. The use of sodium bicarbonate in the meat treatment industry has also been previously reported; and U.S. Pat. No. 7,060,309 describes the use of sodium bicarbonate under vacuum to reduce the number of holes in subsequently cooked meat. In addition, U.S. Pat. No. 6,020,012 describes the use of sodium bicarbonate as an injectable treatment to reduce the rate of pH decline.

Sodium carbonate has also been described before for use in different industries, such as water softening, etc. In most instances, it is used to buffer the pH. U.S. Pat. No. 7,001,630 describes the inferiority of sodium carbonate to enhance water retention when compared to alkali silicates. However, sodium carbonate is usually associated with liquid foodstuffs.

Accordingly, there is a need to provide methods for treating meat products to enhance moisture retention and the present invention addresses such a need. The compositions that are useful in the practice of the present invention satisfy such a need, and can be used in the form of an injectable, a marinate or a rub for meat, poultry, seafood and shellfish, etc. When used to treat meat products, the compositions increases the organoleptic characteristics of the meat, such as increasing the tenderness and juiciness of the product, while reducing drip loss and increasing yields of the cooked product.

### SUMMARY OF THE INVENTION

The present invention is a method of processing meat to enhance moisture retention comprising the steps of: providing a portion of uncooked meat; preparing a phosphate-free composition that includes the following ingredients per 100 lbs of uncooked meat: from about 0.05 to 0.25 pounds of sodium chloride; from about 0.075 to 0.25 pounds of sodium carbonate; from about 0.45 to 0.9 pounds of dextrose; from about 0.01 to 0.054 pounds of citric acid. The composition is then used to treat the meat with up to 30% by weight of the composition until essentially all of the composition is retained by the meat. Such treated meat exhibits an enhanced yield after being cooked.

The meat can be treated by, for example, forming the composition as a dry blend and rubbing the composition on to the meat. Alternatively, the composition can be formed by mixing the composition ingredients together into an aqueous solution such as water, then treating the meat with the aqueous composition by marinating, injecting or tumbling the meat with the composition.

In one embodiment, the composition also includes from about 0.01 to 0.25 pounds of sodium acetate per 100 pounds of uncooked meat. It may also include from about 0.01 to 0.1 pounds of natural flavorings per 100 pounds of uncooked meat, or both sodium acetate and natural flavorings.

Following treatment, the meat is generally cooked to a temperature safe for human consumption. Prior to cooking, it can be stored under refrigeration or it can be frozen.

Any type of meat can be treated according to the method of the present invention, such as chicken, fish, beef, pork and lamb.

Other aspects of the invention are described throughout the specification.

### DETAILED DESCRIPTION OF THE PREFERRED EMBODIMENTS

The present invention is in the field of processing and treating meat. More particularly, the present invention relates to a method of processing meat to enhance moisture retention during both storage and cooking. Enhanced moisture retention results in improved texture, color, and tenderness of the meat.

The meat to be treated with the method of the present invention can include, without limitation, poultry, lamb, beef, veal, pork, fish, shellfish, etc. In particular, the more hearty fish, such as halibut, shark, yellowtail, tuna and swordfish, have a tendency to dry out when cooked and become stringy. Using the method of the present invention, the meat is maintained in a more natural state after cooking.

In one embodiment, the compositions that are used in the practice of the present invention are phosphate-free aqueous sodium carbonate solutions. Such compositions may also include sodium chloride, dextrose and citric acid. In addition, the compositions may alternately be formed as a dry blend to be used as a rub to treat a meat product. In another embodiment, the compositions may be in the form of a dry blend.

The salt to be included in the composition may be any basic inorganic salt such as sodium chloride or magnesium chloride, but specifically excludes potassium chloride. The salt can also be sea salt. The amount of salt present in the composition is in an amount from about 0.05 to about 0.25 pounds per 100 pounds of uncooked meat, with from about 0.5 to about 0.15 pounds per 100 pounds of uncooked meat being preferable.

Sodium carbonate, Na₂CO₃, is an important component of the compositions used in the practice of the present invention. As opposed to sodium bicarbonate which is a commonly used buffering agent in foodstuffs, sodium carbonate is less commonly used because it raises the pH to an undesirable level. While one might be led to believe that the effervescent qualities of sodium bicarbonate would cause it to enhance moisture retention better than an equivalent amount of sodium carbonate, this is not the case. In fact, sodium carbonate is unique in its ability to achieve a desired pH without compromising flavor or other meat qualities. The amount of sodium carbonate present in the composition used is usually from about 0.075 to about 0.25 pounds per 100 pounds of uncooked meat, such as from about 0.1 to about 0.2 pounds per 100 pounds of uncooked meat.

A saccharide (monosaccharide, disaccharide, or polysaccharide) is usually included in the composition as a bulking agent, but also serves as a flavoring agent. Monosaccharides include, for example, glucose, fructose, mannose, galactose, ribose, and xylose. Disaccharides include, for example, sucrose (‘table sugar’), lactose, maltose, maltodextrose, dextrose, cellulose, starch, as well as polymers of glucose, fructose, mannose, galactose, ribose, and xylose, etc., either alone or in combination. The amount of saccharide in the composition is usually from about 0.45 to about 0.9 pounds per 100 pounds of uncooked meat, but can be from about 0.6 to about 0.7 pounds per 100 pounds of uncooked meat.

Acetic acid or its salt, such as sodium or calcium acetate, is also usually included in the composition. Note that acetic acid may form sodium acetate in the presence of sodium carbonate. Accordingly, the acetic acid may be added in the form of vinegar. The amount of acetic acid present in the composition is from about 0.01 to about 0.25 pounds per 100 pounds of uncooked meat.

An anti-oxidant (such as a reducing agent, like citric acid) may also be included in the composition. The amount of anti-oxidant present in the composition is normally from about 0.01 to about 0.06 pounds per 100 pounds of uncooked meat, such as from about 0.03 to about 0.04 pounds per 100 pounds of uncooked meat.

Optional natural flavorings such as rosemary extracts may also be included in the composition, normally in an amount from about 0.01 to about 0.1 pounds per 100 pounds of uncooked meat, such as from about 0.02 to about 0.03 pounds per 100 pounds of uncooked meat.

The composition is applied to the meat usually by using up to 30% of the composition by meat weight until the meat retains essentially all the composition. For each meat, the percentage needed to accomplish maximum retention will vary, but can be determined using routine optimization to avoid wasting excess composition.

The composition can also be optimized to achieve a desired final amount of brine, or salt, retained by the meat, to give the treated meat the right amount of salty flavor. This can be accomplished by optimizing both the overall amount of composition used, as well as the concentration of salt in the composition.

The composition is applied by any suitable means, including injection, dipping, immersion, infusion, perfusion, spraying, tumbling, rubbing or marinating, and may take place under vacuum, atmospheric pressure or above, or by any other suitable means. In addition, application may occur at ambient temperature, in the cold or at elevated temperatures.

Following application of the composition, the meat product may be further processed by packaging, chilling, freezing, etc., prior to being cooked.

Cooking of the meat product may be accomplished by any known method, such as but not limited to, conventional oven, industrial smoke house or steam house, frying, boiling, cooking in a bag and/or casings.

“Cooked weight” is understood to mean the weight of the meat product when the meat product reaches the desired internal temperature (or “cooked temperature”) safe for human consumption.

“Cooking weight” is determined by adding together the green weight plus the weight of the composition retained. For example, 100 pounds of meat plus 20% (i.e, 20 pounds) of the composition equals a cooking weight of 120 pounds.

“Enhanced moisture retention” or “enhanced yield” is understood to mean that the ratio of the cooked weight to the green weight (i.e., “yield”) for a meat product that is processed with the composition of the present invention prior to cooking is greater than the ratio of the cooked weight to the green weight for a meat product that is unprocessed and cooked under the same conditions (i.e., same green weight, time and temperature.)

“Green weight” is understood to mean the weight of the meat product before cooking and processing.

The term “yield of the meat” or “yield” is understood to mean the ratio of the cooked weight to the green weight of the meat.

A “thumb and fork” pressure test is used to measure the firmness of the cooked meat, and to determine whether juices from the meat come out under slight pressure. To perform the thumb and fork pressure test, a fork is placed in the non-dominate hand and pressure is gently applied to the top of the meat. perform the thumb and fork pressure test, a fork is placed in the non-dominate hand and pressure is gently applied to the top of the meat.

It should be understood that the term “untreated meat” or “unprocessed meat” means the meat is in its natural state after being slaughtered, harvested, shucked or de-shelled. Untreated meat is used throughout the subsequent examples as a point of comparison.

When untreated chicken breasts are cooked, they tend to appear dried out or have a twisted, string-like appearance. This dried out or twisted string-like appearance also makes the chicken breast undesirable and or unpalatable to most people. When the composition is infused in practicing the present invention into a skinless, boneless chicken breast, the meat fibers appear very natural after cooking. Additionally, the meat retains moisture while cooking, so it is plump and juicy after cooking. Such functionality can have economic implications to meat processors such as: 1) reduced formulation costs due to substitution of protein with the composition of the present invention; 2) reduced raw material inputs to cooking processes due to higher yields; and 3) increased customer satisfaction with natural looking fresh or cooked products. Meat products treated in accordance with the present invention, although categorized as processed, have a natural appearance, mouth feel and enhanced flavor.

The ingredients used to produce the compositions are dissolves in water or other liquid, and thereafter the composition is usually used as a marinate or injectable for meat. It can also be used without liquid as a dry rub directly on the meat.

In general, an aqueous composition for use in the practice of the present invention is formulated to a specified concentration relative to 100 pounds of uncooked meat, which is the same as saying, 100 pounds green weight of the meat to be processed according to the method of the present invention. In addition, the amount of the composition used to treat the uncooked meat is expressed in terms of a “percent addition rate” in terms of the weight of the composition divided by the weight of the uncooked meat. Thus, for a 100 pound portion of meat that is treated with (and expected to retain) a 12% addition rate, this is the same as saying that the meat is treated with 12 pounds of the composition.

In addition, the weight of the dry ingredients, or “composition ingredients”, that is used to treat the meat is expressed as an “ingoing percent of brine”. Thus, for the example given above, if the composition consists of 1.5 pounds of composition ingredients for every 10.5 pounds of water (i.e., a total weight of 12 pounds, of which 1.5 pounds or 12.5% is attributable to the dry ingredients), the addition rate is 12%. This results in an ingoing percent of brine of 1.5%.

The ingoing percent of brine varies with the type of meat being treated. For example, chicken may have an ingoing percent of 1-2%, whereas read meat such as pork may have an ingoing percent of 0.5-1.5%. In contrast, fish may have an ingoing percent of 0.05 to 0.5%.

Alternatively, the composition may consist only of the composition ingredients in the form of a dry blend.

The composition can also be used on most hearty fish. Some of the more hearty cuts of fish like halibut, shark, yellow tail tuna and swordfish have a tendency to dry out when cooked. When fish are cooked after being marinated in accordance with the present invention, the result is a moist, juicy, tender, natural-looking fillet with an increase in yield that is no dried out or overcooked.

### EXAMPLES

The meat treatment composition that is useful in the practice of the present invention may be prepared as set forth below:

### Example 1

### Preparation of an Exemplary Composition

A meat treatment composition that is useful in the practice of the present invention may be prepared as set forth below:

TABLE 1
Exemplary Aqueous Composition Formulation

| | Pounds per 100 pounds of |
|---|---|
| Ingredient | Uncooked, Untreated Meat |
| Sodium Carbonate | 0.075 to 0.25 |
| Dextrose | 0.45 to 0.90 |
| Sodium chloride | 0.05 to 0.25 |
| Citric acid | 0.01 to 0.06 |
| Sodium acetate | 0.01 to 0.25 |
| Rosemary extract | 0.01 to 0.1 |
| Water | Sufficient for Dissolution (such as |
| | between 5-20 pounds) |

Procedure: The composition was prepared by mixing the above ingredients. The water temperature was raised to 34° F. Mixing was continued until the ingredients were dissolved. The composition was then left to sit for 15-20 minutes. During mixing and preparation, the pH of the composition fluctuated above 10 and below 9.5. The final pH of the composition was between 9.1 and 9.9.

Sodium carbonate was obtained from Cooperative Inc., Los Angeles, Calif. Dextrose was obtained from Cooperative Inc., Los Angeles, Calif. Sodium chloride was obtained from Industrial Commodities, Inc., Los Angeles, Calif. Citric acid was obtained from Westco Chemical Company, Los Angeles, Calif. Sodium acetate was obtained from LA Chemical Company, Los Angeles, Calif. Rosemary extract was obtained from Kalsec Falvor Company, Los Angeles, Calif.

### Example 2

### Meat Treatment

To calculate the amount of the composition needed to add to the meat, the weight of the meat is multiplied by the desired final percent of the composition. For example, if a 20% addition rate is desired, 20 pounds of the composition is added to 100 pounds of meat. This calculation can be found in the USDA Inspectors Handbook Published in 1995, by the United States Department of Agriculture.

The “ingoing percent of brine” is a measure of the amount of solid composition ingredients (referred to herein simply as “composition ingredients”, or “CI”) with which the meat is being treated. It is calculated by taking the amount of the composition ingredients divided by the total amount of the composition ingredients-plus-water times the addition rate. For example, an addition of 0.8 pounds of the composition ingredients and 10 pounds of water at a desired addition rate of 20% would generate an ingoing percent of brine of 1.5%.

TABLE 2
Examples of Ingoing Percent of Brine Added to Meat

| | Desired | Pounds of CI | Ingoing |
|---|---|---|---|
| | Addition | per 10 Pounds | Percent |
| Type of Meat | Rate | of Water | of Brine |
| 4 oz chicken breast, whole* | 20% | 0.8 | 1.5% |
| 6 oz chicken breast, whole | 18% | 0.9 | 1.5% |
| 8 oz chicken breast, whole | 15% | 1.1 | 1.5% |
| 4 oz chicken breast, whole | 12% | 1.43 | 1.5% |
| 6 oz chicken breast, whole | 10% | 1.8 | 1.5% |
| 8 oz chicken breast, whole | 8% | 2.3 | 1.5% |
| 4 oz chicken breast, cut** | 20% | 0.5 | 1.0% |
| 6 oz chicken breast, cut | 18% | 0.6 | 1.0% |
| 8 oz chicken breast, cut | 15% | 0.7 | 1.0% |
| 16 oz chicken breast, cut | 12% | 0.9 | 1.0% |
| 32 oz chicken breast, cut | 10% | 1.1 | 1.0% |
| 4 oz pork loin chop or roast | 20% | 0.25 | 0.5% |
| 6 oz pork loin chop or roast | 18% | 0.3 | 0.5% |
| 8 oz pork loin chop or roast | 15% | 0.31 | 0.5% |
| 16 oz pork loin chop or roast | 12% | 0.4 | 0.5% |
| 32 oz pork loin chop or roast | 10% | 0.56 | 0.5% |
| 3 oz fish fillets*** | 8% | 0.1 | 0.1% |
| 6 oz fish fillets | 10% | 0.13 | 0.1% |
| 8 oz fish fillets | 12% | 0.12 | 0.1% |
| 12 oz fish fillets | 14% | 0.09 | 0.1% |
| 14 oz fish fillets | 15% | 0.05 | 0.1% |

*Boneless and skinless
**Diced or Julienne cut
***Halibut, Shark, Swordfish or Tuna

### Example 3

### Tumbled Chicken Breasts with 1.5% Ingoing Brine

In this example, 0.8 pounds of the composition ingredients described in Example 1 were added to ten pounds of water (in the form of eight pounds of water plus two pounds of ice) to achieve an addition rate of 20% and an ingoing brine of 1.5%. The temperature during mixing was 34° F. The composition was mixed until the ingredients were dissolved. The composition was then left for 15-20 minutes. During mixing and preparation, the pH of the composition fluctuated, but the final pH of the composition was approximately 9.5.

TABLE 3
Boneless, Skinless Chicken Breast Tumbled under Vacuum

| | Desired | Pounds of CI | Ingoing |
|---|---|---|---|
| | Addition | per 10 Pounds | Percent |
| Type of Meat | Rate | of Water | of Brine |
| 4 oz chicken | 20% | 0.8 | 1.5% |
| 6 oz chicken | 18% | 0.9 | 1.5% |
| 8 oz chicken | 15% | 1.1 | 1.5% |
| 4 oz chicken | 12% | 1.43 | 1.5% |
| 6 oz chicken | 10% | 1.8 | 1.5% |
| 8 oz chicken | 8% | 2.3 | 1.5% |

The composition can be added to the meat in several ways, as described in the above specification. One such way is to use a vacuum tumbler. In this example, a 4 ounce boneless, skinless chicken breast was either: untreated, treated with a solution of 20% of a sodium phosphate blend (sodium phosphate at 0.35 to 0.5 pounds per 100 pounds of uncooked meat and sodium chloride at 0.5 to 1 pound per 100 pounds of uncooked meat) (Phosphate Composition), or treated with the composition described in Example 1 (Test Composition) in such a way that the final concentration of ingoing brine was 1.5%.

a. Initial Test

The chicken and solution were placed into a tumbler. (A tumbler is a vessel with a cylindrical shape, the interior of which has veins or blades in order to create friction while the vessel is turning or tumbling.) A vacuum was then applied to the contents of the tumbler. The chicken was then tumbled at a revolution rate of about 6 to 10 revolutions per minute in a 500 pound tumbler for about 15-20 minutes.

After treatment with the Test Composition, the water binding capacity of the meat was improved, and the process efficiency was increased by 40-50%. Additionally, color of the meat was brighter and richer in bloom. It also had a natural appearance, rather then the over-processed and slimy appearance of meat that some sodium phosphate treatments produce. The meat treated with the Phosphate Composition had to be tumbled for an additional 25 minutes, because there was substantial free moisture in the tumbler cavity at the first 20 minute mark. This is in contrast to the chicken treated with the composition described in Example 1, where there was no moisture in the tumbler cavity after 20 minutes of tumbling.

After the meat was tumbled in the vacuum, it was cooked in a conventional kitchen oven. The boneless, skinless chicken breast, either untreated, treated with the Phosphate Composition or treated with the Test Composition, was placed on a rack in a standard cooking dish. The meat was cooked to an internal temperature of 175-180° F. After cooking, the chicken breast was removed from the oven and placed on a cutting board.

After the chicken breast had cooled for approximately 10 minutes, the chicken breast was cut in one of two different ways. In one way, the meat was cubed to a size of about ½ inch by ½ inch, in the other way, the meat was sliced the long ways in about ¼ inch thick pieces to create a fajita-style or Philly Steak-style appearance. After the meat was cubed, it was examined for moisture content. It was observed that very little of the moisture wept out or was cooked out during cooking. The thumb and fork pressure test was used to measure the firmness of the cooked meat, and to determine whether juices from the meat were released under slight pressure. The cubed meat was firm and had an excellent response to thumb and fork pressure. The meat cubes sprang back into the cubed shape without changing the natural appearance or loosing moisture. In contrast, the untreated meat remained almost flat, and the meat treated with the Phosphate Composition sprang back slightly, but released large dollops of moisture and did not hold the desired cubed shape.

b. Effect of Freezing/Thawing

To simulate the effect of cooked meat undergoing a freezing followed by further processing at a later date, the untreated cubed chicken was frozen for seven days and then thawed at 37° F. for about one full day. Treatment and cooking was performed as described above. The untreated meat had a tough, chewy and dry mouth feel, as well as a rigid stringy appearance. The meat treated with the Phosphate Composition showed signs of heavy moisture loss and spongy, gritty, slimy mouth feel, and it appeared smooth and over-processed. The meat treated with the Test Composition had very little to no weeping or loss of moisture, and it had a natural appearance. Even after cooking and freezing, it was similar in appearance to the cooked samples that were not frozen. It was also observed that the meat treated with the Test Composition did not have the warmed-over flavor associated with freezing and thawing meats. Accordingly, he meat treated with Test Composition held up through the initial processing; cooking, freezing, thawing and then reheating, and outperformed the other samples in all areas of measurement.

c. Ready-to-Eat Simulation

A simulation of a ready-o-at product, like a burrito or chicken dinner, which would be fully cooked at a processor, followed by freezing and re-cooking in a microwave or conventional oven, was also performed. The frozen, cubed chicken was either microwaved for 1 to 3 minutes, or cooked for 6-8 minutes in a conventional oven set at 325° F.

After either microwaving or cooking, the untreated meat had a stringy and dried-out appearance, and was very tough to chew. After either microwaving or cooking, the meat treated with the Phosphate Composition had a processed look and a gritty texture when chewed. Additionally, a lot of the moisture had released from the chicken breast and was in the bottom of the cooking tray. The meat treated with the Test Composition had very little to no moisture loss after reheating. Again, the meat did not have the warmed-over flavor that is commonly associated with frozen, thawed and reheated meat, and held its natural appearance, juiciness, tenderness and overall integrity whether microwaved or cooked in a conventional oven.

### Example 4

### Tumbled or Injected Chicken Breast with 1.0% Bngoing Brine

In this example, 0.5 pounds of the composition ingredients described in Example 1 were added to ten pounds of water (in the form of eight pounds of water plus two pounds of ice) to achieve an addition rate of 20% and an ingoing brine concentration of 1.0%. The temperature during mixing was 34° F. The composition was mixed until all the composition ingredients were dissolved. The composition was then left for 15-20 minutes. During mixing and preparation, the pH of the composition fluctuated, and the final pH of the composition was around 9.5.

TABLE 4
Chicken Breast Tumbled with 1.0% Ingoing Brine

| | | | |
|---|---|---|---|
| | Desired | Pounds of CI | Ingoing |
| | Addition | per 10 Pounds | Percent |
| Weight of Meat | Rate | of Water | of Brine |

| | | | | |
|---|---|---|---|---|
| 4 | oz | 20% | 0.5 | 1.0% |
| 6 | oz | 18% | 0.6 | 1.0% |
| 8 | oz | 15% | 0.7 | 1.0% |
| 16 | oz | 12% | 0.9 | 1.0% |
| 32 | oz | 10% | 1.1 | 1.0% |

a. Machine Tumbled without Vacuum

This example demonstrates that the Test Composition is functional when tumbled with meat in the absence of vacuum. Boneless, skinless chicken breast pieces were either: untreated, marinated in a 20% solution of Phosphate Composition or marinated in a 20% solution of the Test Composition.

The chicken containing either composition was then placed into a tumbler. The chicken was tumbled at 6 to 10 revolutions per minute in a 500 pound tumbler for about 15-20 minutes. The Phosphate Composition came out of the tumbler with most of the solution not being infused into the meat. In contrast, even in the absence of vacuum, the meat treated with the Test Composition remained more natural looking. Additionally, solution infused into the meat at almost 100%, and the meat did not look over processed.

b. Hand Tumbled without Vacuum

This example demonstrates that even with no vacuum and hand tumbling of the meat, the Test Composition infuses into the meat. Hand tumbling means hand massaging the meat by flipping it over from one end to another, ensuring that the solution covers all parts. Hand massaging simulates the action of an industrial tumbler.

In this example, chicken breast were either untreated, marinated with a 20% solution of Phosphate Composition, or marinated with a 20% solution of Test Composition. Either solution was hand massaged into the meat for 8-10 minutes. The meat was then allowed to soak in the remaining marinade for about 20 minutes. Only about 25% of the Phosphate Composition infused into the meat, leaving a significant amount of solution left. Using the Test Composition, 100% of the solution was infused.

### Example 5

### Pork Loin Chops or Roast Injected with the Test Composition at 0.5% Ingoing Brine

In this example, 0.25 pounds of the composition ingredients were added to ten pounds of water (in the form of eight pounds of water plus two pounds of ice) to achieve an addition rate of 20% and an ingoing brine of 0.5%. The composition temperature was 34° F. during mixing. The composition was mixed until all the composition ingredients were dissolved. The composition was then left for 15-20 minutes. During mixing and preparation, the pH of the composition fluctuated, but the final pH of the composition was around 9.5.

TABLE 5
Injected Pork Loin Chops or Pork Roast - Refrigerated and Frozen

| | Desired | Pounds of CI | Ingoing |
|---|---|---|---|
| | Addition | per 10 Pounds | Percent |
| Type of Meat | Rate | of Water | of Brine |
| 4 oz Pork Loin Chop | 20% | 0.25 | 0.5% |
| 6 oz Pork Loin Chop | 18% | 0.3 | 0.5% |
| 8 oz Pork Loin Chop | 15% | 0.31 | 0.5% |
| 16 oz Pork Roast | 12% | 0.4 | 0.5% |
| 32 oz Pork Roast | 10% | 0.56 | 0.5% |

A whole pork loin was either untreated or injected with the Phosphate Composition or the Test Composition. A pork loin weighing approximately 6.5 pounds before treatment weighed approximately 7.8 pounds after treatment. Four roasts weighing 2 pounds each were cut from the whole pork loin. Two of the loins were frozen, while the other two were refrigerated for further processing for 24 hours.

Meat that was injected with a 20% solution of the Test Composition showed very little to no weeping or moisture loss in the holding tray. On the other hand, the meat treated with the Phosphate Composition left moisture and juices in the holding tray. Both roasts were placed on a roasting rack and cooked to an internal temperature of 162° F. The meat was then removed from the oven and allowed to stand for 15 minutes. At this time, the meat was sliced into ¼ inch portions. The meat injected with the Test Composition exhibited very little weeping or juice loss. Additionally, the mouth feel and tenderness of the meat was natural and more appealing. The meat treated with the Phosphate Composition had a gritty, processed like appearance after slicing. There were also large amounts of purge or cook-off in the bottom of the cooking tray using the Phosphate Composition. Meat treated with the Test Composition had at least 30-50% more moisture left behind than the Phosphate Composition treated meat. The untreated pork roast was very dry and unpalatable to the bite.

The frozen pork roasts were kept frozen for 7 days, and then thawed to about 36° F. The meat that had been treated with the Test Composition had significantly less moisture in the holding tray after thawing than did the meat treated with the Phosphate Composition. The roasts were then cooked in a conventional oven to an internal temperature of 162° F. The roasts were then removed from the oven and allowed to cool for about 15 minutes. The roasts were then sliced into ¼ inch portions. The roast treated with the Phosphate Composition had significant moisture loss during cooking and after cooling. It also had a warmed-over flavor and a gritty mouth feel. The meat treated with the Test Composition showed very little weeping or juice loss during cooking. Additionally, the mouth feel and tenderness of the roast treated with the Test Composition was more appealing and natural, and the roast held its natural flavor during the freezing-thawing-cooking processes.

### Example 5

### Fish, Shrimp and Scallops Treated with the Test Composition at 0.5% Ingoing Brine

In this example, 0.7 pounds of the composition ingredients were added to ten pounds of water (in the form of eight pounds of water plus two pounds of ice) to achieve an addition rate of 20% and an ingoing brine of 0.5%. The composition temperature was 34° F. during mixing. The composition was mixed until all the composition ingredients were dissolved. The composition was then left for 15-20 minutes. During mixing and preparation, the pH of the composition fluctuated, but the final pH of the composition was around 9.5.

TABLE 6
Marinated Fish, Shrimp and Scallops

| | | | |
|---|---|---|---|
| | Desired | Pounds of CI | Ingoing |
| | Addition | per 10 Pounds | Percent |
| Weight of Meat | Rate | of Water | of Brine |

| | | | | |
|---|---|---|---|---|
| 3 | oz | 8% | 0.7 | 0.5% |
| 6 | oz | 10% | 0.5 | 0.5% |
| 8 | oz | 12% | 0.41 | 0.5% |
| 12 | oz | 14% | 035 | 0.5% |
| 14 | oz | 15% | 0.32 | 0.5% |

a. Shark Fillets

Shark meat is typically dense, meaty, pinkish-white flesh that is low in fat, firm in texture, and moderately strong in flavor (some steaks and fillets contain darker sections of reddish meat that have a more pronounced flavor). Additionally, it is a very hearty fish that is prone to off-flavors and drying out while cooking.

In this example, 2 lbs of shark fillet were laid flat in a holding tray. They were then either untreated, or were marinated with the Phosphate Composition or the Test Composition for 10 minutes. They were then gently agitated by hand until the solution was absorbed, which took approximately five minutes. The fillets were then either frozen for 7 days or refrigerated for 24 hours. The Phosphate Solution remained uninfused. However, the 8% solution of the Test Composition was 100% infused into the meat.

The frozen fillets were thawed to 37° F. The refrigerated or previously frozen shark fillets were cooked until the fish became opaque, about 4 minutes per side, at 400° F. The shark fillets that were marinated with the Test Composition were more tender and moist when compared to the untreated fillets. There was also no discernible difference between the fillets that were frozen for 7 days as compared to the fillet that was refrigerated for 24 hours. The fillets treated with the Test Solution were also easier to handle, and they did not flake off or fall apart when handled. Additionally, the mouth feel and tenderness were excellent compared to the non-treated shark fillets. The shark fillet treated with the Phosphate Composition did not look as natural as fillets treated with the Test Composition, and they were a bit more flaky and harder to handle in the pan. The fillets also had a salty, chemical, spongy mouth feel when eaten. The cooked untreated fillet was dry and undesirable and fell apart while cooking.

b. Scallops

Approximately thirty medium sized scallops totaling about one pound were placed in a holding tray. They were then either untreated, or marinated with the Phosphate Solution or the Test Solution for ten minutes. They were then gently agitated by hand until the solution was absorbed, which took approximately ten minutes. Using the Test Solution, 100% of the solution was infused into the meat. A portion of the scallops were frozen for 7 days, and some were refrigerated for 24 hours. The refrigerated scallops treated with the Test Composition did not exhibit appreciable weeping or moisture into the holding tray. The scallops were cooked using high heat for four minutes per side in a nonstick frying pan with a small amount of non-stick spray only. The scallops were then quartered. The scallops that were marinated with the Test Solution were significantly more juicy, tender and more flavorful when eaten. They also performed well in the fork and thumb pressure test than the non-treated scallops or the scallops treated with the Phosphate Composition. The scallops treated with Phosphate Composition also purged most of the moisture into the frying pan and shrunk in size during cooking. They were moist inside, but chewy. The untreated scallops cooked with the same method also shrunk in size and were very dry and chewy when eaten and were not palatable.

c. Raw Shrimp

About forty medium sized raw, shelled shrimp totaling about one pound were placed in a holding tray. They were then either untreated or marinated in the Phosphate Composition or the Test Composition. They were then gently agitated by hand until the solution was absorbed, which took approximately 5 minutes. Using the Test Solution, 100% of the solution was infused into the meat. On the other hand, the shrimp treated with the Phosphate Solution picked up some of the solution, but not all of it.

Some of the shrimp were frozen for 7 days, and some refrigerated for 24 hours.

The refrigerated shrimp treated with the Test Composition, and exhibited very little to no weeping or moisture in the holding tray. The shrimp were cooked using high heat for two minutes per side in a nonstick frying pan with a small amount of non-stick spray only. The shrimp that were marinated with the Test Composition were significantly more juicy and tender to fork and thumb pressure than were the non-treated shrimp. They were also tender when bitten into. In addition, the shrimp treated with the Test Composition held their flavor better and did not have a warmed over flavor. This held true when cooked different ways: grilled, boiled and sautéed.

The shrimp treated with the Phosphate Composition were cooked with the same method. These shrimp purged most of the moisture into the frying pan and shrunk in size when completely cooked. They were not moist inside and were very chewy.

The examples set forth above are provided to give those of ordinary skill in the art with a complete disclosure and description of how to make and use the preferred embodiments of the compositions, and are not intended to limit the scope of what the inventors regard as their invention. Modifications of the above-described modes (for carrying out the invention that are obvious to persons of skill in the art) are intended to be within the scope of the following claims. All publications, patents, and patent applications cited in this specification are incorporated herein by reference as if each such publication, patent or patent application were specifically and individually indicated to he incorporated herein by reference.

What is claimed is:

1. A method of processing meat to enhance moisture retention comprising the steps of:
a. providing a portion of uncooked meat;
b. preparing a phosphate-free composition comprising:
from about 0.05 to 0.25 pounds of sodium chloride per 100 pounds of uncooked meat;
from about 0.075 to 0.25 pounds of sodium carbonate per 100 pounds of uncooked meat; and
from about 0.45 to 0.9 pounds of dextrose per 100 pounds of uncooked meat; and
from about 0.01 to 0.054 pounds of citric acid per 100 pounds of uncooked meat;
c. treating the meat with up to 30% by weight of the composition until essentially all of the composition is retained by the meat;
wherein the meat when cooked exhibits an enhanced yield.

2. The method according to claim 1, wherein the composition is a dry blend and the step of treating the meat further comprises rubbing the meat with the composition.

3. The method according to claim 1, wherein the composition further comprises water and the step of treating the meat further comprises marinating, injecting or tumbling the meat with the composition.

4. The method according to claim 1 wherein the composition further comprises from about 0 to 0.25 pounds of sodium acetate per 100 pounds of uncooked meat.

5. The method according to claim 1, wherein the composition further comprises from about 0 to 0.1 pounds of natural flavorings per 100 pounds of uncooked meat.

6. The method according to claim 1, wherein the composition further comprises from about 0 to 0.25 pounds of sodium acetate per 100 pounds of uncooked meat and from about 0 to 0.1 pounds of natural flavorings per 100 pounds of uncooked meat.

7. The method according to claim 1 further comprising the step of cooking the meat to a temperature safe for human consumption.

8. The method according to claim 7 further comprising the step of storing the meat after treating the meat and before cooking the meat.

9. The method according to claim 8, wherein the step of storing the meat further comprises refrigerating or freezing the meat.

10. The method according to claim 1, wherein the meat is selected from the group consisting of: chicken, fish, beef, pork and lamb.
